(19) United States
(12) Patent Application Publication
(10) Pub. No.: US 2016/0178339 A1
(43) Pub. Date: Jun. 23, 2016

(54) INSTALLATION TOOL

(71) Applicant: BRYAN KNOWLTON, SAN ANGELO, TX (US)

(72) Inventor: BRYAN KNOWLTON, SAN ANGELO, TX (US)

(21) Appl. No.: 14/579,466

(22) Filed: Dec. 22, 2014

(51) Int. Cl. G01B 3/14

(52) U.S. Cl. CPC G01B 3/14

(57) ABSTRACT

Embodiments disclosed herein describe systems and methods for utilizing tools to size holes to be cut in drywall. Embodiments of the tool described herein may assist a user in determining a correct size and placement of a hole to be cut. The holes may be cut in a wall, ceiling, floor, etc. of a wall. Responsive to cutting the hole a duct supply boot may be installed.

### BACKGROUND INFORMATION

1. Field of the Disclosure

Examples of the present disclosure are related to systems and methods for an installation tool. More particularly, embodiments relate to a tool that is used to install heating and cooling supply boots and/or ducts.

2. Background

Ducts and supply boots are used in heating, ventilation, and air conditioning systems (HVAC) to deliver and remove air from a wall. The needed airflows include supply air, return air, and exhaust air. Utilizing ducts and supply boots, heated and cooled air may be transported to different areas within a wall. Accordingly, to transport the air within the walls, modern walls require ducts and supply boots.

When installing ducts and supply boots into a wall, installers are required to cut holes in drywall, a wall, a ceiling, etc. to access the inputs and outputs of the ducts. Conventionally, to cut a hole in the drywall, an installer uses a ruler to mark the desired size of the hole. Subsequently, the installer cuts the hole based on his markings with the ruler.

However, the process of aligning and leveling a ruler to be the size and shape of a desired hole is time consuming and potentially not accurate. Furthermore, if a hole is cut incorrectly, then the drywall must be repaired. Thus, conventional methods for cutting holes for ducts and supply boots are inefficient.

Accordingly, needs exist for more effective and efficient systems and methods for marking holes to be cut, where the markings are associated with the installation of ducts and supply boots.

### SUMMARY

Embodiments disclosed herein describe systems and methods for a tool to shape and/or size holes to be cut in drywall. The tool described herein may assist a user in determining a correct size and placement of a hole to be cut. The holes may be cut in a wall, ceiling, floor, etc. of a wall. Responsive to cutting the hole, a duct supply boot may be installed within the hole.

In embodiments, the tool may include a first channel, a second channel, a coupling mechanism, a plurality of cutouts, and a carpenter's square.

The first channel may be an indentation, depression, groove, etc. that extends from a first side of the tool to a second side of the tool. The first channel may have a width that is slightly larger than that of the carpenter's square, and the first channel may have a height that corresponds with the height of the carpenter's square. Accordingly, when the carpenter's square is positioned within the first channel, a top surface of the carpetner's square may be level with a surface of the tool.

The second channel may be an indentation, depression, groove, etc. that extends from a third side of the tool to a fourth side of the tool. The second channel may have a width that is slightly larger than that of the carpenters square, and the second channel may have a height that corresponds with the height of the carpenters square. Accordingly, when the carpenter's square is positioned within the second channel, a top surface of the carpetner's square may be level with a surface of the tool.

In embodiments, the first channel and the second channel may be aligned in directions that are perpendicular to each other.

The coupling mechanism may be a set screw knob. The screw knob may be configured to secure the carpenter's square at a desired location within the first channel or the second channel. In embodiments, the coupling mechanism may also be configured to be loosened. Responsive to loosening the coupling mechanism, the carpenter's square may slide within the first or second channel. Additionally, after loosening the coupling mechanism the carpenter's square may be moved between the first and second channel.

The plurality of cutouts may be holes, orifices, etc. that extend through the body of the tool. More specifically, each of the plurality of cutouts may extend from a top surface of the tool to the bottom surface of the tool. Accordingly, a user may make markings on a surface underneath the tool when the tool is positioned on the surface.

In embodiments, the cutouts may be shaped to correspond with desired sized of holes for conventional duct supply boots. For example, the plurality of cutouts may be positioned at predetermined intervals through the tool, wherein the predetermined intervals corresponding to desired shapes and/or sizes of duct supply boots.

The carpenter's square is a device that is configured to establish right angles. The carpenter's square may have a first leg and a second leg, wherein the first leg is positioned at a direction perpendicular to the second leg. Responsive to inserting one of the legs into one of the channels, an end of the inserted leg may be positioned adjacent to an edge of a wall of a wall. By positioning the end of the inserted leg adjacent to the edge of a wall, markings may be made on drywall through the tool via the cutouts. Accordingly, the markings may be either perpendicular to the edge of the wall and/or parallel to the edge of the wall. Utilizing the markings, a hole may be cut through the drywall.

Utilizing embodiments, users may be able to more efficiently shape and cut holes within drywall, as well as improved accuracy in the dimensions of the holes.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts one embodiment of a top view of a tool utilized to shape holes to be cut.

FIG. 2 depicts one embodiment of an exploded, perspective view of a tool utilized to shape holes to be cut.

FIG. 3 depicts one embodiment of an exploded, back view of a tool utilized to shape holes to be cut.

FIG. 4 depicts one embodiment of a perspective view of a tool utilized to shape holes to be cut.

FIG. 5 depicts one embodiment of a method for using a tool to shape holes to be cut.

FIG. 6 depicts one embodiment of a top view of a tool utilized to shape holes to be cut.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Embodiments disclosed herein describe systems and methods for utilizing tools to size holes to be cut in drywall. Embodiments of the tool described herein may assist a user in determining a correct size and placement of a hole to be cut. The holes may be cut in a wall, ceiling, floor, etc. of a wall. Responsive to cutting the hole a duct supply boot may be installed.

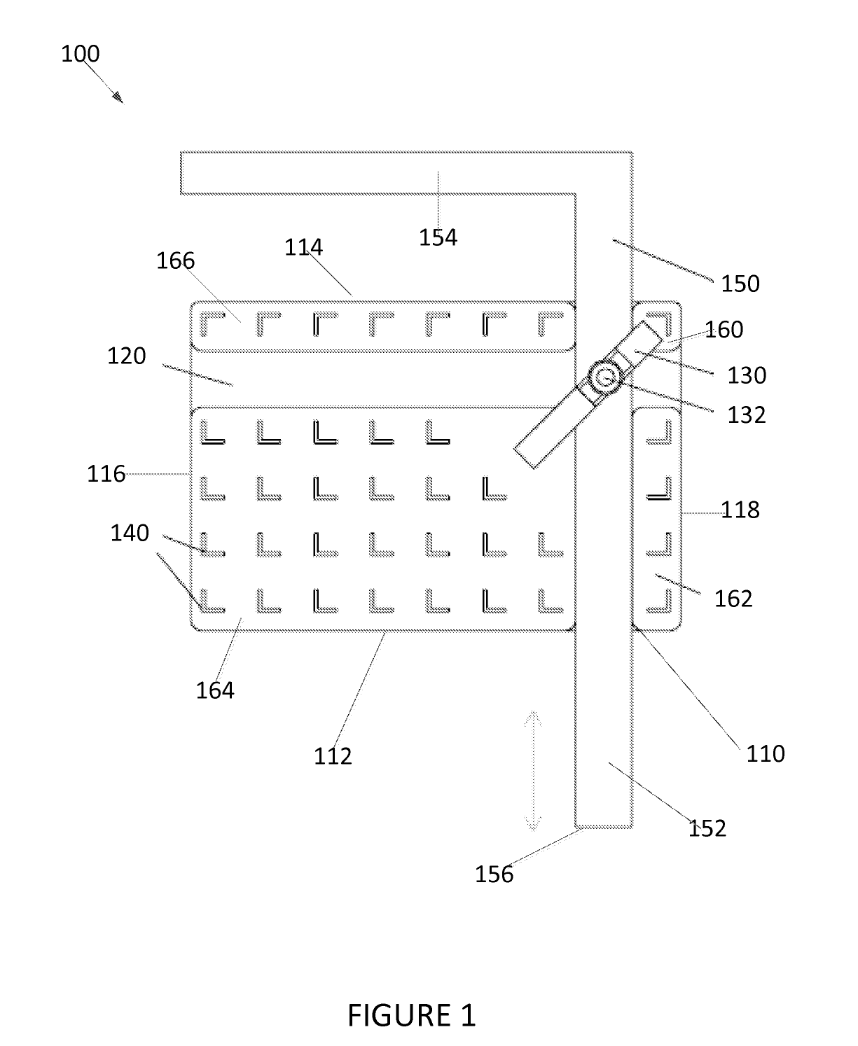

Turning now to FIG. 1, FIG. 1 depicts a tool 100 configured to assist a user to size holes to be cut in drywall. Tool 100 may assist the user in determining the correct size and placement of a hole to be cut, wherein the hole may be cut in a wall, ceiling, floor, etc. of a wall. Responsive to cutting the hole, a duct supply boot may be installed.

Tool 100 may include a first channel 110, a second channel 120, a coupling mechanism 130, a plurality of cutouts 140, and a carpenters square 150.

First channel 110 may be an indentation, depression groove, etc. that extends from a first side 112 of tool 100 to a second side of tool 114. First channel 110 may have a width that is slightly larger than the width of carpenters square 150. Accordingly, if carpenters square 150 is inserted into first channel 110, the sides of a first leg 152 of carpenters square 150 may be positioned adjacent to the sidewalls of first channel 110. Furthermore, first channel 110 may have a depth that corresponds with the height of carpenter's square 150. Accordingly, when carpenter's square 150 is positioned within first channel 110, a top surface of carpenter's square 150 may be level with a surface of tool 100.

Second channel 120 may be an indentation, depression groove, etc. that extends from a third side 116 of tool 100 to a fourth side 118 of tool 100. The distance between first side 112 to second side 114 may be less than the distance between third side 116 and fourth side 118. Second channel 120 may have a width that is slightly larger than the width of carpenters square 150. Accordingly, if carpenters square 150 is inserted into second channel 110, the sides of a first leg 152 of carpenters square 150 may be positioned adjacent to the sidewalls of second channel 120. Furthermore, second channel 120 may have a depth that corresponds with the height of carpenter's square 150. Accordingly, when carpenter's square 150 is positioned within second channel 120, a top surface of carpetner's square 150 may be level with a surface of tool 100.

First channel 110 may be positioned proximate to fourth side 118 of tool 100, and second channel 120 may be positioned proximate second side 114 of tool 100. Furthermore, first channel 110 and second channel 120 may be perpendicular to each other.

Coupling mechanism 130 may be configured to allow carpenter's square 150 to move within first channel 110 or second channel 120. Additionally, coupling mechanism 130 may be configured to allow carpenter's square 150 to be removed from and inserted into first channel 110 or second channel 120. Moreover, coupling mechanism 130 may be configured to allow carpenter's square 150 to be in a fixed position within first channel 110 or second channel 120. Coupling mechanism 130 may be configured to be positioned across an intersection of first channel 110 and second channel 120, wherein when carpenters square 150 is positioned within first channel 110 or second channel 120, an upper surface of carpenters square 150 may be positioned adjacent to a lower surface of coupling mechanism 130. In further embodiments, tool 100 may include a plurality of coupling mechanisms 130, wherein a first coupling mechanism may extend across at least a portion of first channel 110 and a second coupling mechanism may extend across at least a portion of second channel 120.

Coupling mechanism 130 may include tightening device 132. Tightening device 132 may be a screw, rivet, fastener, etc. that is configured to extend through coupling mechanism. A lower surface of tightening device 132 may be configured to be dynamically move between a first position and a second position. When tightening device 132 is in the first position, the lower surface of tightening device 132 may interface with carpenters square 150 to secure carpenters square 150 in a fixed position. Responsive to tightening device 132 being in the second position, carpenters square 150 may freely move within the first channel 110 and/or the second channel.

The plurality of cutouts 140 may be holes, orifices, etc. that extend through the body of tool 100. Accordingly, a user may make markings underneath tool 100 when the tool is positioned on a wall's surface via the plurality of cutouts 140. The plurality of cutouts 140 may be shaped to correspond with the desired sized of holes for conventional duct supply boots. To account for different sized holes with standard sizing, the plurality of cutouts 140 may be positioned at even intervals throughout tool 100. Each of the plurality of cutouts 140 may be comprised of two lines, wherein a first of the lines is configured to be parallel to first channel 110 and a second of the lines is configured to be parallel to second channel 120.

The plurality of cutouts 140 may be positioned in four quadrants: a first quadrant 160, a second quadrant 162, a third quadrant 164, and a fourth quadrant 166. Each of the cutouts positioned in the same quadrant may be aligned the same. However, the alignment of the cutouts in different quadrants may be different.

First quadrant 160 may be positioned at an upper right hand corner of tool 100, and may include a single cutout. The single cutout may also be used as the upper right hand boundary of the desired marking to cut the drywall. The single cutout in first quadrant 160 is the benchmark used to ensure proper spacing of all other cutouts.

Second quadrant 162 may be positioned at a lower right hand corner of tool 100, which may be positioned to the right of first channel 110 and below second channel 120. Second quadrant 162 may be comprised of a single column of cutouts, wherein any of the cutouts within second quadrant 162 may be utilized to define a lower right hand corner of the markings to be cut.

Third quadrant 164 may be positioned at a lower left hand corner of tool 100, which may be positioned to the left of first channel 110 and below second channel 120. Third quadrant 164 may be comprised of a plurality of columns and rows of cutouts, wherein any of the cutouts within third quadrant 164 may be utilized to define a lower left hand corner of the markings to be cut.

Fourth quadrant 166 may be positioned at an upper left hand corner of tool 100, which may be positioned to the left of first channel 110 and above second channel 120. Fourth quadrant 166 may be comprised of a single row of cutouts, wherein any of the cutouts within fourth quadrant 166 may be utilized to define an upper left hand corner of the markings to be cut.

One skilled in the art will appreciate that if carpenter's square 150 is inserted into second channel 120, the corners defined by the plurality of cutouts in different quadrants may be changed. For example, if carpenter's square 150 is inserted into second channel 120, the cutout positioned in first quadrant 160 may define the upper left corner of the hole to be cut.

Carpenter's square 150 that may a device that is configured to establish right angles. Carpenter's square 150 may have a first leg 152 and a second leg 154, wherein the first leg 152 is positioned at a direction perpendicular to the second leg 154. Responsive to inserting one of the legs into one of the channels, an end 156 of the inserted leg may be positioned adjacent to a surface of the wall. When positioning the end 156 of the inserted leg adjacent to the edge of the wall, markings may be made on drywall through tool 100 via the plurality of cutouts 140.

Utilizing the markings, a hole may be cut through the drywall. Furthermore, by aligning end 156 of the inserted leg adjacent to the edge of the wall, each of the markings through tool 100 will either be perpendicular or parallel to the edge of the wall. Therefore, an accurate and aligned hole may be cut through the drywall.

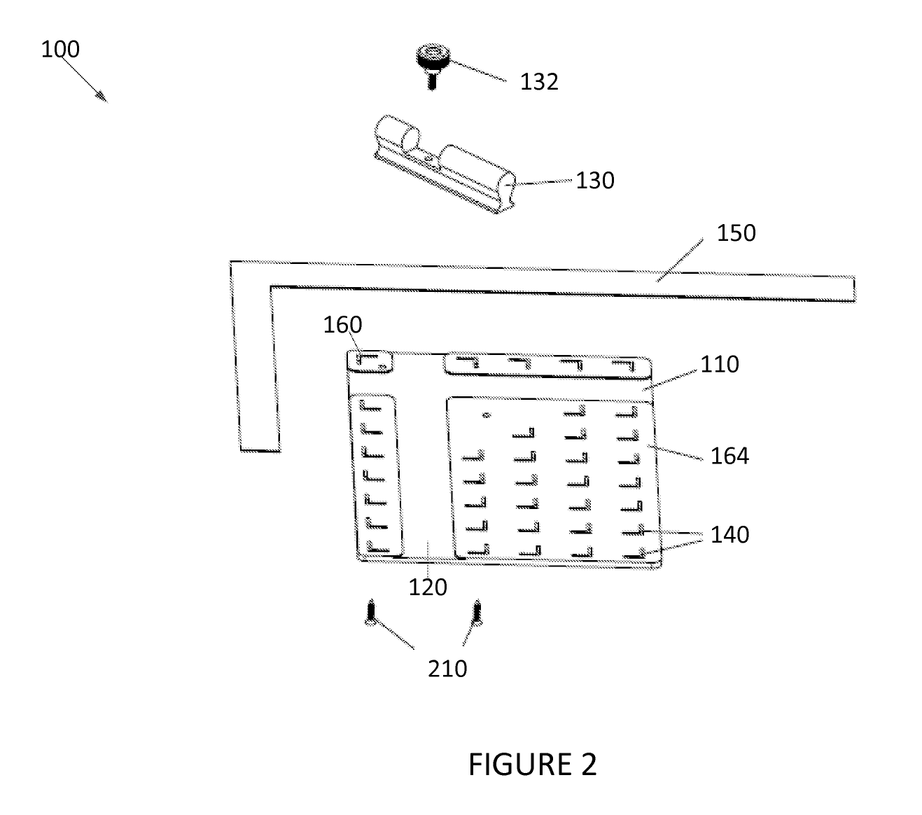

FIG. 2 depicts an exploded view of tool 100. As depicted in FIG. 2, coupling mechanism 130 may be coupled to tool 100 via a plurality of screws 210. A first screw may be inserted through a bottom of tool 100 into a portion of coupling mechanism 130 positioned over first quadrant 160, and a second screw may be inserted through a bottom of tool into a portion of coupling mechanism 130 positioned over third quadrant 164. Accordingly, coupling mechanism 130 may be held in place over an intersection of first channel 110 and second channel 120.

Furthermore, as depicted in FIG. 2, first channel 110 and second channel 120 may have the same depth and width, but different lengths. Therefore, if it is desired to cut holes that are different lengths or longer sides, or holes that are closer or further away from a surface of a wall, then carpenter's square 150 may be inserted into a different channel.

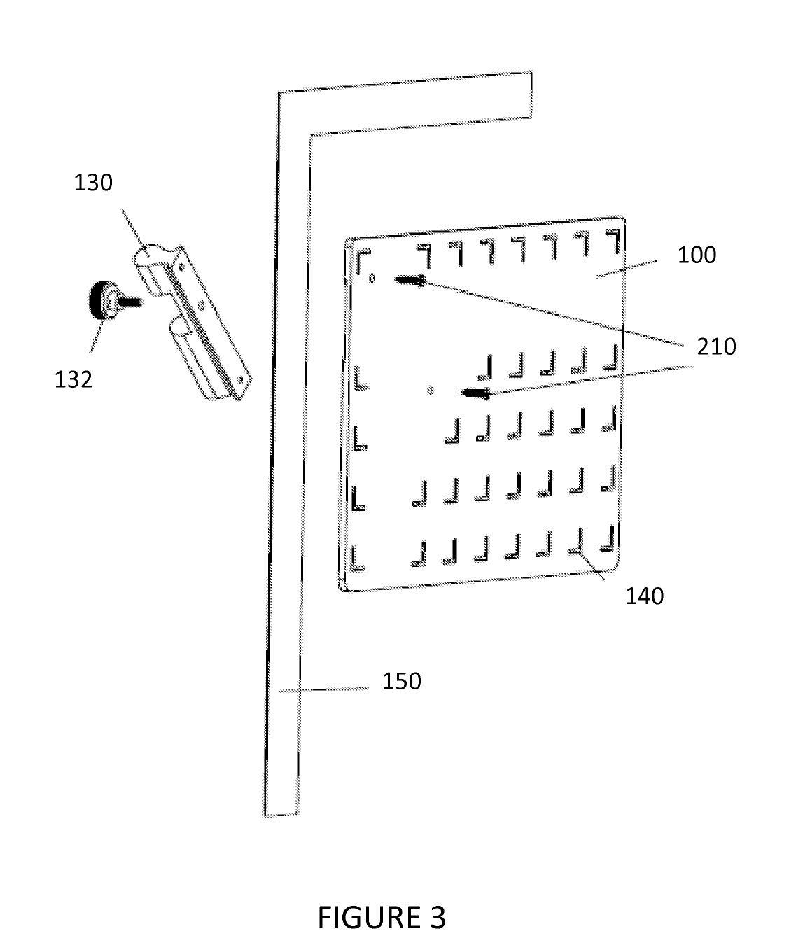

FIG. 3 depicts a back view of tool 100. As depicted in FIG. 3, each of the plurality of cutouts 140 may extend through a surface of tool 100. Therefore, a user may make marks to cut a hole on drywall through tool 100.

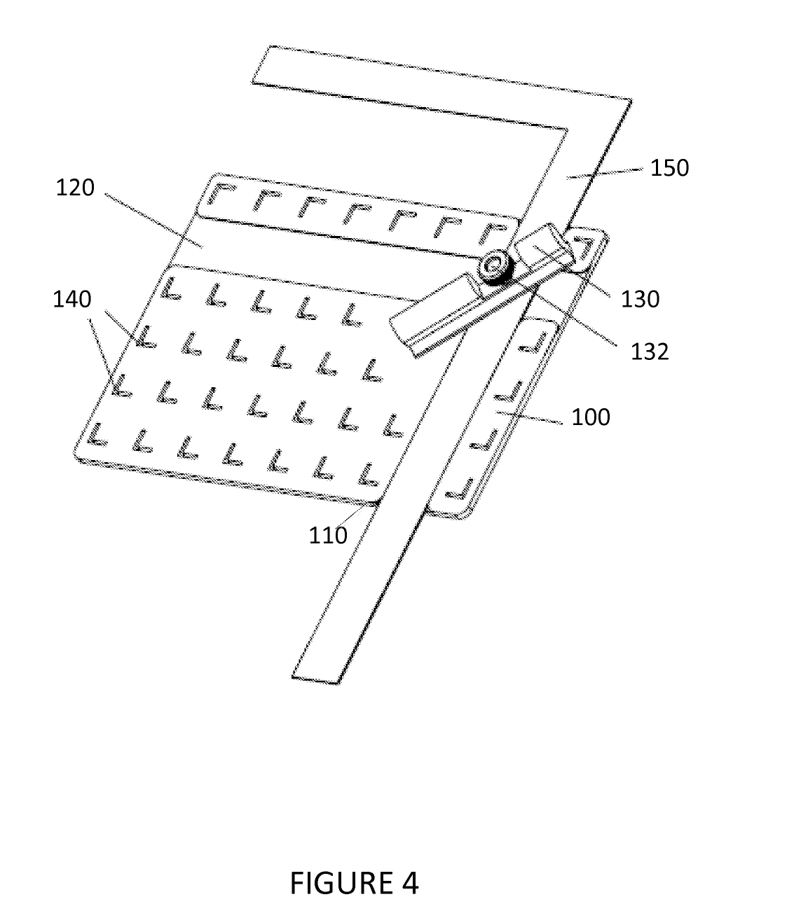

FIG. 4 depicts one embodiment of a perspective view of tool 100. As depicted in FIG. 4, tool 100 may be slide in and out of first channel 110 based on the desired

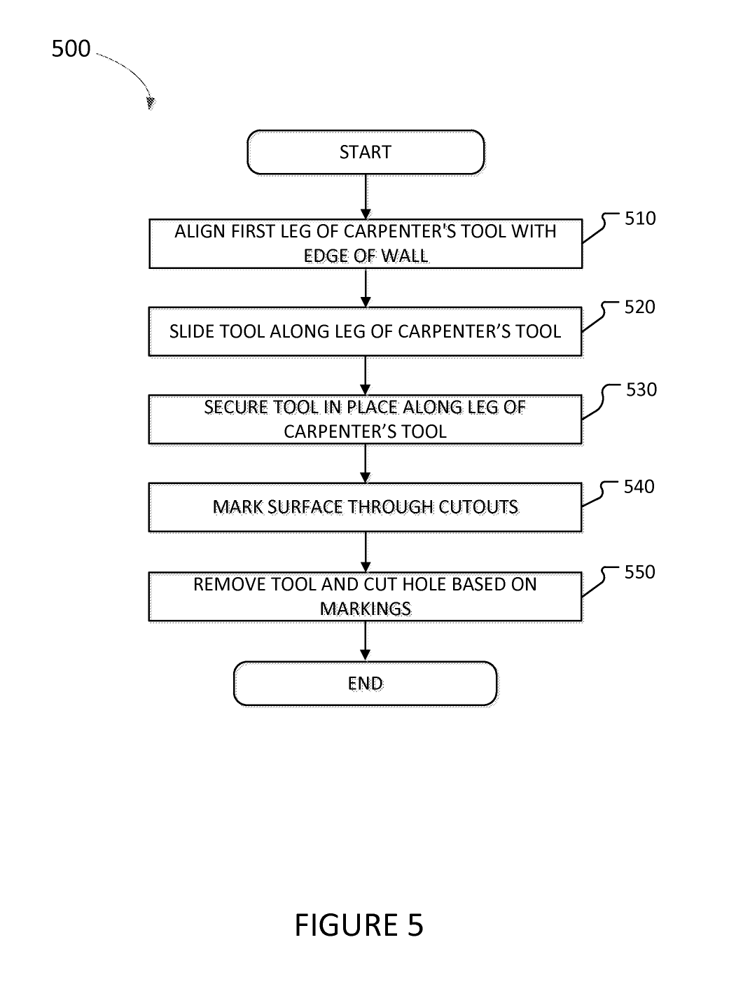

FIG. 5 depicts a method 500 for creating markings delineating a hole to be cut. The operations of method 500 presented below are intended to be illustrative. In some embodiments, method 500 may be accomplished with one or more additional operations not described, and/or without one or more of the operations discussed. Additionally, the order, wherein the operations of method 700 are illustrated in FIG. 5 and described below is not intended to be limiting.

At operation 510, a first leg of a carpenter's square may be slid into a first channel of the tool. An end of the first leg may be positioned coincident with an edge of a wall, such that the tool is positioned over the surface of the wall to create the hole. By aligning the end of the first leg of the carpenters square with the edge of the wall, markings made through cutouts within the tool may be either perpendicular or parallel to the edge of the wall.

At operation 520, the tool may be slid up or down the first leg of the carpenters' square until the tool is positioned in the location where the hole is desired to be cut.

At operation 530, responsive to placing the tool over the desired surface to mark the hole, a tightening mechanism may be moved to secure the tool in place. Responsive to the tightening mechanism being moved, the tool may be set at a fixed location along the first leg of the carpenters square.

At operation 540, markings on the surface of the wall may be made through a plurality of cutouts. The markings made through the tool may delineate a hole to be cutout. In embodiments, markings may be made through cutouts positioned within at least four quadrants on the tool.

At operation 550, the tool may be removed, and a hole may be cut on the surface of the material based on the markings made through the tool.

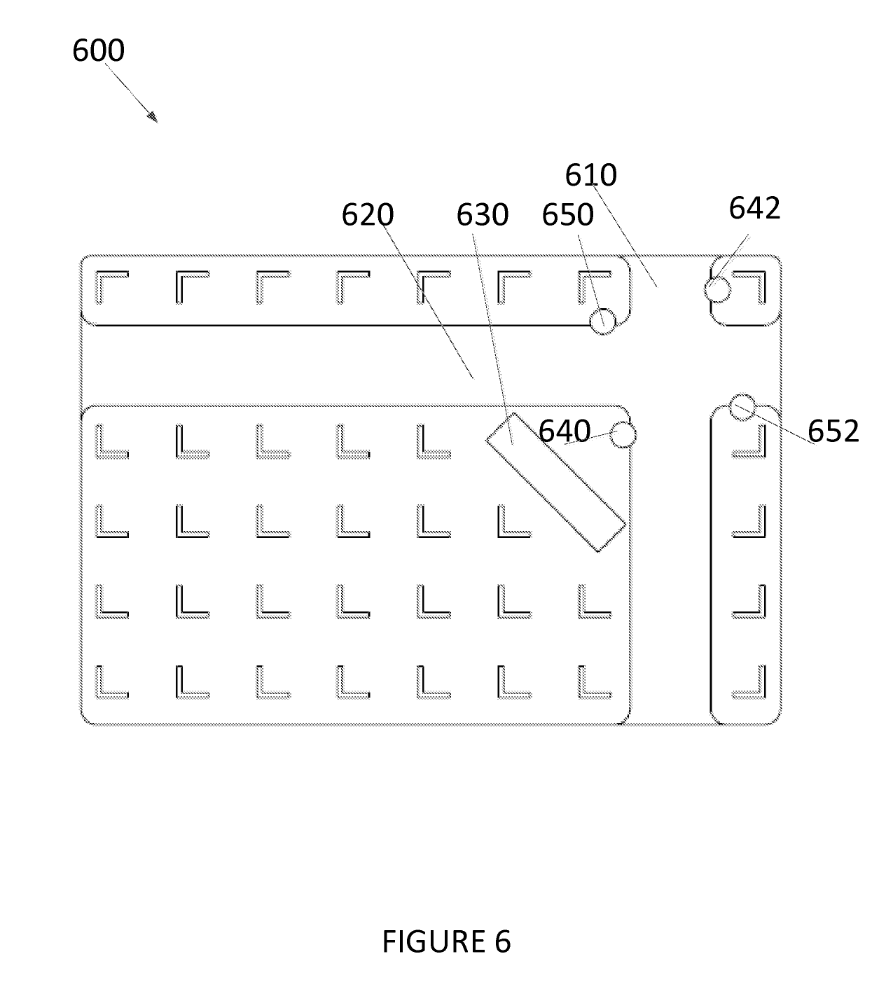

FIG. 6 depicts one embodiment of a top view of a tool 600 utilized to shape holes to be cut. As depicted in FIG. 6, tool 600 may include two sets of coupling mechanisms, wherein a first set of coupling mechanisms may include disks 640 and disk 642 and a second set of coupling mechanisms may include disks 650 and 652.

Disks 640 and 642 may be positioned on opposite sides of first channel 610, and a portion of each of the disks 640, 642 may extend across first channel 610. When a carpetner's square is inserted into first channel 610, a top surface of the carpetner's square may be positioned adjacent to the portion of disks 640, 642 extending over first channel 610. In embodiments, disks 640 and 642 may be configured to interface with the carpenter's square to hold the carpetner's square in place.

Disks 650 and 652 may be positioned on opposite sides of second channel 620, and a portion of each of the disks 650, 652 may extend across second channel 620. When a carpetner's square is inserted into second channel 620, a top surface of the carpetner's square may be positioned adjacent to the portion of disks 650, 652 extending over second channel 620. In embodiments, disks 650 and 652 may be configured to interface with the carpenter's square to hold the carpetner's square in place.

Tool 600 may also include a handle 630. Handle 630 may be a strap, attachment, grip, etc. that is configured to allow a user to move tool 600 or secure tool 600 in place. In embodiments, a user may insert their hand, finger, tools, etc. into handle 630 to achieve a reliable grip on tool 600.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

What is claimed is:

1. A tool for delineating a hole for installing heating or cooling supply boots, the tool comprising:
a body having a first side, a second side, a third side, and a fourth side;
a first channel extending from the first side to the second side;
a second channel extending from the third side to the fourth side;
a coupling mechanism extending over the first channel and the second channel, the coupling mechanism including a tightening device, wherein the tightening device is configured to secure a ruler within the first channel or the second channel; and
a plurality of cutouts extending through the body of the tool, the plurality of cutouts being positioned at predetermined intervals across the body.

2. The tool of claim 1, wherein the first channel and the second channel are positioned perpendicular to one another, and intersect to form a plurality of quadrants on the body.

3. The tool of claim 2, wherein a first quadrant includes only a first cutout, and when a first marking is made through the first cutout, the first cutout is set at a first orientation that represents the upper right hand corner of the hole.

4. The tool of claim 3, wherein a second quadrant includes a column, the column being comprised of a first set of the plurality of cutouts, each of the plurality of cutouts within the first set being configured to represent a lower right hand corner of the hole when a second marking is made through the body, wherein each of the plurality of cutouts within the first set has a second orientation.

5. The tool of claim 4, wherein a third quadrant includes a plurality of rows and columns, the plurality of rows and columns being comprised of a second set of the plurality of cutouts, each of the plurality of cutouts within the second set being configured to represent a lower left hand corner of the hole when a third marking is made through the body, wherein each of the plurality of cutouts within the second set has a third orientation.

6. The tool of claim 5, wherein a fourth quadrant includes a row, the row being comprised of a third set of the plurality of cutouts, each of the plurality of cutouts within the third set being configured to represent a upper left hand corner of the hole when a fourth marking is made through the body, wherein each of the plurality of cutouts within the third set has a fourth orientation.

7. The tool of claim 6, wherein the first orientation, second orientation, third orientation, and fourth orientation are each different orientations.

8. The tool of claim 1, wherein a first mode a lower surface of the tightening device is configured to extend through and past a lower surface of the coupling mechanism, and in a second mode the lower surface tightening device is configured to be retracted into the coupling mechanism.

9. The tool of claim 8, wherein the first mode the lower surface of the tightening device is configured to interface with the ruler to secure the ruler in a fixed position, and in the second mode the lower surface of the tightening device is not configured to interface with the ruler and the ruler is free to slide within the first channel and the second channel.

10. The tool of claim 1, wherein a lower edge of the ruler is configured to be positioned on an edge of a surface where the hole is to be placed.

11. A method of using a tool to delineating a hole for installing heating or cooling supply boots, the method comprising:
moving a ruler within a first or second channel, wherein the first and second channels are located within a body of the tool, the first channel extending from a first side of the body to a second side of the body;
extending a tightening device through a coupling mechanism to secure the rule within the first channel or the second channel, wherein the coupling mechanism extends over the first channel and the second channel;
forming marks through a plurality of cutouts that extend through the body of the tool, the plurality of cutouts being positioned at predetermined intervals across the body.

12. The method of claim 11, wherein the first channel and the second channel are positioned perpendicular to one another, and intersect to form a plurality of quadrants on the body.

13. The method of claim 12, wherein a first quadrant includes only a first cutout; and
forming a first marking through the first cutout, the first marking is set at a first orientation that represents the upper right hand corner of the hole.

14. The method of claim 13, wherein a second quadrant includes a column, the column being comprised of a first set of the plurality of cutouts, each of the plurality of cutouts within the first set has a second orientation; and
forming a second marking through at least one of the first set of the plurality of cutouts, the second marking representing a lower right hand corner of the hole.

15. The method of claim 14, wherein a third quadrant includes a plurality of rows and columns, the plurality of rows and columns being comprised of a second set of the plurality of cutouts, each of the plurality of cutouts within the second set being configured to represent a lower left hand corner of the hole when a third marking is made through the body, wherein each of the plurality of cutouts within the second set has a third orientation and
forming a third marking through at least one of the second set of the plurality of cutouts, the third marking representing a lower left hand corner of the hole.

16. The method of claim 15, wherein a fourth quadrant includes a row, the row being comprised of a third set of the plurality of cutouts, wherein each of the plurality of cutouts within the third set has a fourth orientation.
forming a fourth marking through at least one of the third set of the plurality of cutouts, the fourth marking representing an upper left hand corner of the hole.

17. The method of claim 16, wherein the first orientation, second orientation, third orientation, and fourth orientation are each different orientations.

18. The method of claim 11, further comprising:
extending, in a first mode, a lower surface of the tightening device through and past a lower surface of the coupling mechanism; and
retracting, a second mode, the lower surface tightening device into the coupling mechanism.

19. The method of claim 18, further comprising:
interfacing, in the first mode, the lower surface of the tightening device with the ruler to secure the ruler in a fixed position;
not interfacing, in the second mode, the lower surface of the tightening device with the ruler; and
moving the ruler within the first channel or the second channel in the second mode.

20. The method of claim 11, further comprising:
positioning a lower edge of the ruler an edge of a surface where the hole is to be placed.
